(19) United States
(12) Patent Application Publication
(10) Pub. No.: US 2004/0030530 A1
(43) Pub. Date: Feb. 12, 2004

(54) Apparatus and method for detection of direct sequence spread spectrum signals in networking systems

(76) Inventors: Kuo-Hui Li, Hsinchu (TW); Hung-Kun Chen, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/613,297

(22) Filed: Jul. 3, 2003

Related U.S. Application Data
(63) Continuation-in-part of application No. 10/062,116, filed on Jan. 30, 2002.

(51) Int. Cl. G06F 15/00; G06F 17/18; G06F 101/14

(52) U.S. Cl. 702/179

(57) ABSTRACT

An apparatus and method for detection of direct sequence spread spectrum signals in 802.11b/g systems. First, a sample sequence is taken from a preamble of a newly arrived network packet. The next step is to calculate a sequence of correlation measures between the sample sequence and a pseudo-noise code sequence of length L. An accumulation sequence is then calculated in which each accumulation value thereof is obtained by summing N correlation measures that are selected at an interval of L from the sequence of correlation measures. Also, a statistic of the sample sequence is evaluated over a multiple of L number of samples. Based on a comparison between the statistic of the sample sequence and a predetermined threshold scaled by the maximum of the accumulation sequence, the presence of direct sequence spread spectrum signals can be determined accordingly.

### BACKGROUND OF THE INVENTION

1. Field of the Invention

The invention relates to wireless networking, and more particularly to a detection scheme of Direct Sequence Spread Spectrum (DSSS) signals for a receiver in a wireless communication system using Barker sequence as the spreading code.

2. Description of the Related Art

With the emergence of a converged standard for wireless local area networks (WLANs), the stage is set for a multimode marketplace. Much like its wired predecessor, wireless Ethernet (802.11) will flourish in an environment characterized by multimode operation. Convergence of the separate 10- and 100-megabit per second technologies of wired Ethernet into the now familiar 10/100 networks accelerated the market's acceptance of wired Ethernet. The same should be expected of WLAN technology and the merging of the 802.11b and 802.11a versions of the standard into 802.11g.

In 1997, the first wireless Ethernet standard, known simply as 802.11, was adopted and published by the IEEE. This unified standard provided several modes of operation and data rates up to a maximum two megabits per second (Mbps). Work soon began on improving the performance of 802.11. The eventual results were two new but incompatible versions of the standard, 802.11b and 802.11a. The “b” version operated in the same frequency range as the original 802.11, the 2.4 GHz Industrial-Scientific-Medical (ISM) band, but the “a” version ventured into the 5 GHz Unlicensed National Information Infrastructure (U-NII) band. 802.11b mandated complementary code keying (CCK) for rates of 5.5 and 11 Mbps, and included as an option Packet Binary Convolutional Coding (PBCC) for throughput rates of 5.5 and 11 Mbps, and additional range performance. It also supported fallback data rates of 2 Mbps and 1 Mbps, using the same Barker coding used in the original 802.11 standard. The underlying transmission technology supporting 802.11b was Direct Sequence Spread Spectrum (DSSS). 802.11a turned to another multi-carrier coding scheme, Orthogonal Frequency Division Multiplexing (OFDM), and achieves data rates up to 54 Mbps. Because 802.11b equipment was simpler to develop and build, it arrived in the marketplace first. 802.11b technology soon established a foothold in the market and proved the viability of WLAN technology in general.

In March of 2000, the IEEE 802.11 Working Group formed a study group to explore the feasibility of extending the 802.11b standard to data rates greater than 20 Mbps in the 2.4 GHz spectrum. For a year and a half, this group, which came to be known as the Task Group G, studied several technical alternatives until it finally adopted a hybrid solution that included the same OFDM coding and provided the same physical data rates of 802.11a. But this version of the draft standard, 802.11g, occupied the 2.4 GHz band of the original 802.11 standard. On Jun. 12, 2003, IEEE announced its final approval of the IEEE 802.11g standard. Several optional coding schemes were incorporated into 802.11g, including CCK-OFDM and PBCC, the latter of which provides alternative data rates of 22 and 33 Mbps. Briefly, the IEEE 802.11g standard requires the use of OFDM for data rates up to 54 Mbps and requires the support for CCK to ensure backward compatibility with existing 802.11b radios as mandatory parts. Because it integrates two technical solutions that had been totally separate and quite incompatible, the 802.11g standard thereby provides for true multimode operations.

Therefore, not only 802.11b but also 802.11g systems, or any other communication system using Barker sequence as spreading code must have the capability to discriminate DSSS signals from other co-channel radios in a multimode environment. But waveforms of DSSS, OFDM, Bluetooth operating in the same 2.4 GHz band and white noise are quite random so it is difficult for an 802.11b compatible system to distinguish between them. In particular, the detection probability of a valid 802.11b compatible packet is required to exceed 90% within 4 μs when a receive level is above −82 dBm. The false-alarm probability, which means the probability of mistakenly detecting an 802.11b compatible packet as other radios received, must be kept low enough to ensure a good packet error rate (PER) for high network throughput. In view of the above, what is needed is an efficient scheme of DSSS detection to meet the requirements.

### SUMMARY OF THE INVENTION

It is an object of the present invention to provide a detection mechanism of DSSS signals for 802.11b compatible systems.

The present invention is generally directed to an apparatus and method for detection of DSSS signals in a multimode WLAN environment. According to one aspect of the invention, the apparatus of the invention is made up of a decision making unit and a detection unit including a first, second and third means. The detection unit takes a sample sequence from a preamble of a newly arrived network packet. The first means is configured to calculate a sequence of correlation measures between the sample sequence and a pseudo-noise code sequence of length L, where L is a positive integer. The second means is configured to calculate an accumulation sequence in which each accumulation value thereof is obtained by summing N correlation measures that are selected at an interval of L from the sequence of correlation measures, where N is a predetermined integer number. The third means is employed to evaluate a statistic of the sample sequence over a multiple of L number of samples. Based on a comparison between the statistic of the sample sequence and a predetermined threshold scaled by the maximum of the accumulation sequence, the decision making unit is capable of determining whether the newly arrived network packet comprises a DSSS waveform.

According to another aspect of the invention, a method for detection of DSSS signals in 802.11b or 802.11g receivers is proposed. First, a sample sequence is taken from a preamble of a newly arrived network packet. The next step of the method is to calculate a sequence of correlation measures between the sample sequence and a pseudo-noise code sequence of length L, where L is a positive integer. An accumulation sequence is then calculated in which each accumulation value thereof is obtained by summing N correlation measures that are selected at an interval of L from the sequence of correlation measures, where N is a predetermined integer number. Also, a statistic of the sample sequence is evaluated over a multiple of L number of samples. Based on a comparison between the statistic of the sample sequence and a predetermined threshold scaled by the maximum of the accumulation sequence, the presence of DSSS is signals is therefore determined.

### DESCRIPTION OF THE DRAWINGS

The present invention will be described by way of exemplary embodiments, but not limitations, illustrated in the accompanying drawings in which like references denote similar elements, and in which:

FIG. 1 is a flowchart illustrating primary steps for DSSS detection according to the invention;

FIG. 2 is a functional block diagram illustrating a DSSS detection apparatus according to the invention;

FIG. 3 is a graph showing the miss probability vs. the threshold ρ; and

FIG. 4 is a graph showing the false-alarm probability vs. the threshold ρ.

### DETAILED DESCRIPTION OF THE INVENTION

To begin with, the proposed algorithm is introduced herein and derived in terms of mathematical expressions. According to the IEEE 802.11b and 802.11g standards, each legacy 802.11b data packet includes the DSSS PLCP Preamble that uses a pseudo-noise (PN) code sequence spreading with differential binary phase shift keying (DBPSK) modulation, in which the following 11-chip Barker sequence is used as the PN code sequence:

{+1, −1, +1, +1, −1, +1, +1, +1, −1, −1, −1}

The primary property of this Barker sequence is that its periodic autocorrelation function is impulse-like so the Barker sequence exhibits good autocorrelation performance. Also, the Barker sequence is characterized by a partial correlation function that is negative or zero at all time shifts except at the zero time shift. For these reasons, the Barker sequence is ideal for DSSS PLCP Preamble acquisition and detection. Denoting received samples taken from a preamble of a newly arrived network packet by r(0), r(1), . . . , r(n), . . . , in which n represents discrete instances in time. Each sample of the sequence {r(n)} is a complex number in baseband. According to the invention, the sample sequence is correlated with the Barker sequence as follows:

$$C ( n ) = \vert {\sum }_{k = 0}^{L - 1} r ( n - k ) \cdot {b}^{*} ( L - k - 1 ) \vert = \vert {\sum }_{k = 0}^{L - 1} r ( n - k ) \cdot b ( L - k - 1 ) \vert \qquad \text{(1.1)}$$

where superscript * denotes complex conjugation, k denotes an integer index, {b(n)} denotes the Barker sequence of length L, and C(n) is a correlation measure at time instant n. Note that b(n) is the same as b*(n) because each chip code of the Barker sequence is an integer number. Moreover, it is understood to those skilled in the art that equation (1.1) is substantially equivalent to an equation of the form:

$$C ( n ) = \vert {\sum }_{k = 0}^{L - 1} {r}^{*} ( n - k ) \cdot b ( L - k - 1 ) \vert$$

If the received sample has been subjected to upsampling by a factor of N_{U}, the length of the {b(n)} sequence, L, will be equal to N_{U}·l_{C} where l_{C} is the code length of the Barker sequence in “chip”. In the case of a valid legacy 802.11b transmission, the correlation can create a peak due to the properties of the Barker sequence. However, this is not enough to discriminate DSSS signals from other co-channel radios in a multimode environment or channel noise in severe channel conditions. For the purpose of reliability enhancement, N correlation measures selected at an interval of L from the {C(n)} sequence of equation (1.1) are summed together at distinct time instants. That is,

$${A}_{m} ( N ) = {\sum }_{k = 0}^{N - 1} C ( m + k \cdot L ) , m = 0 , 1 , 2 , … , L - 1 \qquad ( 1.2 )$$

where m denotes an integer index. Consequently, the DSSS PLCP Preamble of an 802.11b compatible data packet is detected if the following condition can hold true:

$${max}_{m} \{ {A}_{m} ( N ) \} \cdot ρ > {E}_{r} ( N ) \qquad ( 1.3 )$$

where ρ is a predetermined threshold and Eᵣ(N) denotes a statistic of the {r(n)} sequence over a multiple of L number of samples. Note that Eᵣ(N) is representative of the energy of the {r(n)} sequence over (N−1) times L number of samples, e.g.:

$$\begin{matrix}{E}_{r} ( N ) = {\sum }_{n = 0}^{( N - 1 ) \cdot L - 1} {\vert r ( n ) \vert}^{2} \\ or & ( 1.4 ) \\ {E}_{r} ( N ) = {\sum }_{n = 0}^{N \cdot L - 1} {\vert r ( n ) \vert}^{2} & ( {1.4}^{′} )\end{matrix}$$

For simplicity, the square root of energy is calculated instead. Taking equation (1.4) as an example, Eᵣ(N) can be approximated by:

$${E}_{r} ( N ) = {\sum }_{n = 0}^{( N - 1 ) \cdot L - 1} \vert r ( n ) \vert \qquad ( 1.5 )$$

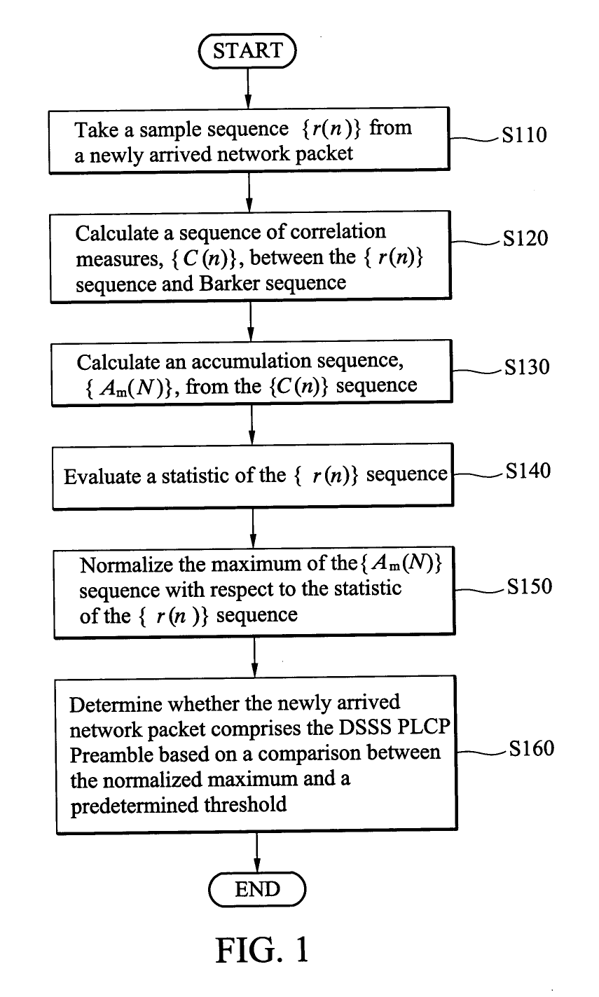

Turning now to FIG. 1, a flowchart of primary steps for DSSS detection in 802.11a/g systems is illustrated. The first step of the invention is to take a sample sequence, {r(n)}, from a preamble of a newly arrived network packet (step S110). Next in step S120, a sequence of correlation measures between the {r(n)} sequence and an 11-chip Barker sequence is calculated. In one embodiment, the received baseband signal has been upsampled by a factor of 2 so the length L of the Barker sequence is equal to 22. Hence, the correlation measure sequence, {C(n)}, is given by:

$$C ( n ) = \vert {\sum }_{k = 0}^{21} r ( n - k ) \cdot b ( 21 - k ) \vert \qquad ( 2.1 )$$

In step S130, an accumulation sequence, {Aₘ(N)}, is calculated for m=0˜L−1, in which each accumulation value thereof is obtained by summing N correlation measures that are selected at an interval of L=22 from the {C(n)} sequence:

$${A}_{m} ( N ) = {\sum }_{k = 0}^{N - 1} C ( m + 22 k ) , m = 0 , 1 , 2 , … , 21 \qquad ( 2.2 )$$

where N is a predetermined integer number. The greater N achieves better detection performance but gives rise to a slower system response. The proposed method can trade off performance with N and system response. Prior to determination of the received preamble, a statistic of the {r(n)} sequence is evaluated over a multiple of L number of samples (step S140). In one embodiment, this statistic is expressed in terms of the energy of the {r(n)} sequence over (N−1) times L number of samples. For example L=22, the statistic, Eᵣ, is given by:

$${E}_{r} ( N ) = {\sum }_{n = 0}^{( N - 1 ) \cdot 22 - 1} {\vert r ( n ) \vert}^{2} \qquad ( 2.3 )$$

For simplicity, the statistic Eᵣ(N) can be approximated by the following equation:

$${E}_{r} ( N ) = {\sum }_{n = 0}^{( N - 1 ) \cdot 22 - 1} \vert r ( n ) \vert \qquad ( 2.4 )$$

It should be understood to those skilled in the art that other forms are contemplated to evaluate the statistic Eᵣ(N) by the principles of the invention. In step S150, the maximum of the {Aₘ(N)} sequence is normalized with respect to the statistic Eᵣ(N). The normalized maximum, NLAₘₐₓ(N), is given by:

$${NLA}_{max} ( N ) = \frac{{max}_{m} \{ {A}_{m} ( N ) \}}{{E}_{r} ( N )} \qquad ( 2.5 )$$

where

$${max}_{m} \{ {A}_{m} ( N ) \}$$

denotes the maximum of the {Aₘ(N)} sequence over L number of effective accumulation values, m=0˜L−1. The procedure of FIG. 1 then proceeds to step S160 where the received baseband signal is determined whether it is the DSSS PLCP Preamble according to a comparison between the normalized maximum NLAₘₐₓ(N) and a predetermined threshold ρ. Hence, if the following decision criterion can hold true:

NLAₘₐₓ(N)>1/ρ (2.6)

then the DSSS PLCP Preamble is detected. It should be understood to those skilled in the art that other criteria are contemplated on the basis of inequality (2.6). For example, another decision criterion can be defined as follows:

NLAₘₐₓ(N)>1/ρ, N=N₁, N₁+1, . . . , N₂ (2.7)

where N₂>N₁, N₁ and N₂ are positive integers. By applying the criterion given in (2.7), the false-alarm probability can be improved but at the cost of lowering the detection probability.

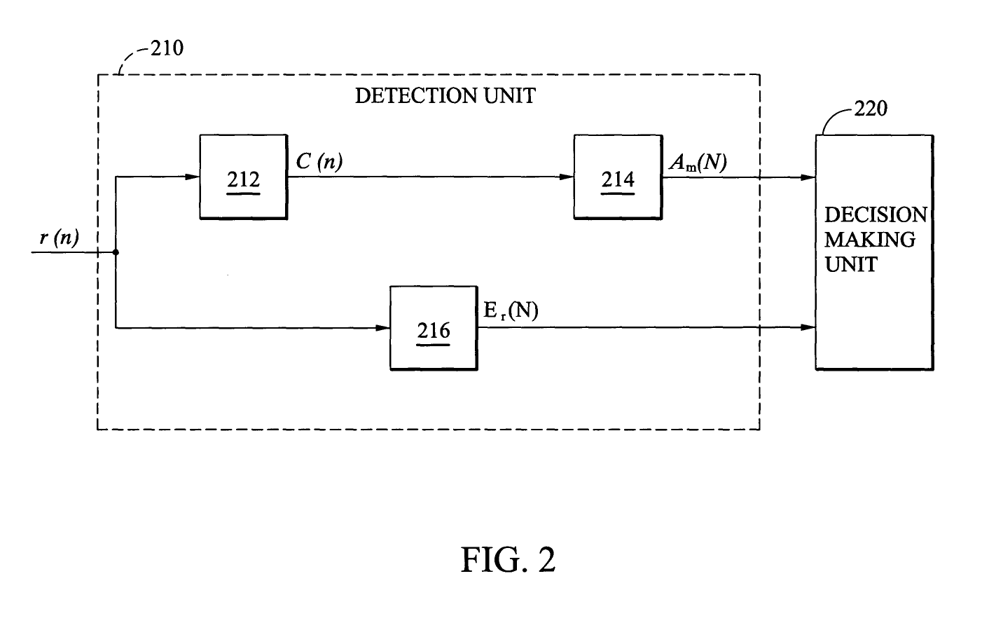

Referring to FIG. 2, a DSSS detection apparatus that realizes the proposed algorithm in an 802.11b compatible system is illustrated. The apparatus of the invention is constituted by a decision making unit 220 and a detection unit 210 including a first, second and third means. The detection unit 210 is adapted to take a sample sequence {r(n)} from a preamble of a newly arrived network packet. It is assumed that the received baseband signal has been upsampled by a factor of 2. Therefore, the length of the Barker sequence, L, is equal to 22. With equation (2.1), the first means 212 calculates correlation measures and forms the {C(n)} sequence. In the meantime, the third means 216 evaluates the statistic Eᵣ(N) using equation (2.3) or (2.4). On the other hand, the second means 214 accumulates selected correlation measures and yields the {Aₘ(N)} sequence by applying equation (2.2). Since division is more difficult than multiplication in hardware implementation, the DSSS detection apparatus of the invention does not perform normalization directly. Instead of equation (2.5), the decision making unit 220 is able to determine the presence of DSSS signals based on a comparison between the statistic Eᵣ(N) and the predetermined threshold ρ scaled by the maximum of the {Aₘ(N)} sequence. To state more precisely, the presence of DSSS signals is declared if the following condition can hold true:

$${max}_{m} \{ {A}_{m} ( N ) \} \cdot ρ > {E}_{r} ( N )$$

If so, the decision making unit 220 identifies the newly arrived network packet as an 802.11b compatible data packet. Alternatively, the following condition is examined:

$${max}_{m} \{ {A}_{m} ( N ) \} \cdot ρ > {E}_{r} ( N ) , N = {N}_{1} , {N}_{1} + 1 , … , {N}_{2}$$

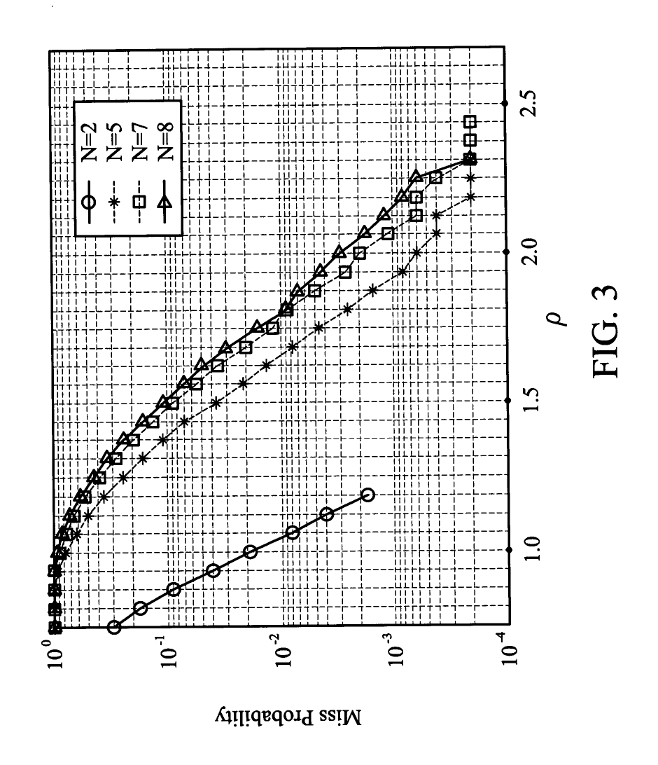

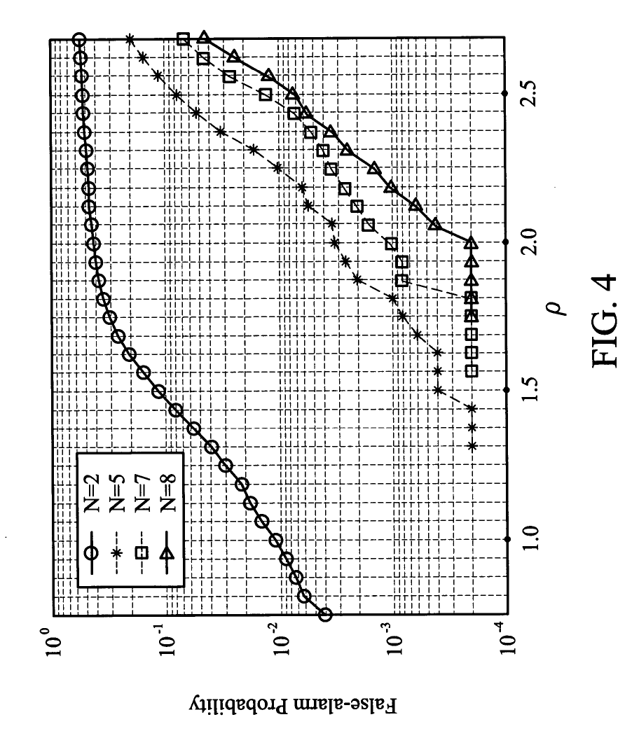

In order to evaluate the detection probability and the false-alarm probability vs. the thresholds for various N, the scheme of the present invention is simulated in a fading channel environment. In the simulation model, it is assumed that the delay spread of the fading channel, τᵣₘₛ, is equal to 125 ns. The miss probability (1−detection probability) vs. ρ for DSSS signals with E_{c}/Nₒ=6 dB using N=2, 5, 7 and 8 is shown in FIG. 3. Furthermore, taking Bluetooth signals with E_{c}/Nₒ=+∞ as an example, the false-alarm probability vs. ρ is shown in FIG. 4. From FIGS. 3 and 4, it can be seen that ρ≈2.2 is acceptable if N is set to 8. Of course, this is not the only choice. In general, there are different threshold values for ρ from different considerations.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for detection of direct sequence spread spectrum signals in networking systems, comprising:
a detection unit adapted to take a sample sequence from a preamble of a newly arrived network packet, comprising:
a first means for calculating a sequence of correlation measures between said sample sequence and a pseudo-noise code sequence of length L, where L is a positive integer;
a second means for calculating an accumulation sequence in which each accumulation value thereof is obtained by summing N correlation measures that are selected at an interval of L from said sequence of correlation measures, where N is a predetermined integer number;
a third means for evaluating a statistic of said sample sequence over a multiple of L number of samples; and
a decision making unit for determining the presence of direct sequence spread spectrum signals based on a comparison between said statistic of said sample sequence and a predetermined threshold scaled by the maximum of said accumulation sequence.

2. The apparatus as recited in claim 1 wherein said accumulation sequence comprises L number of effective accumulation values and said second means calculates said accumulation sequence, {Aₘ(N)}, from said correlation measure sequence, {C(n)}, by the following equation:
$${A}_{m} ( N ) = {\sum }_{k = 0}^{N - 1} C ( m + k \cdot L ) , m = 0 , 1 , 2 , … , L - 1$$
where n denotes a time instant, m denotes an integer index, C(n) denotes one of said correlation measures at time instant n, and Aₘ(N) denotes one of said accumulation values at index m.

3. The apparatus as recited in claim 2 wherein said decision making unit declares the presence of direct sequence spread spectrum signals if the following condition can hold true:
$$\frac{{max}_{m} \{ {A}_{m} ( N ) \}}{{E}_{r} ( N )} > 1 / ρ$$
where
$${max}_{m} \{ {A}_{m} ( N ) \}$$
denotes the maximum of said accumulation sequence, Eᵣ(N) denotes said statistic of said sample sequence, and ρ is said predetermined threshold.

4. The apparatus as recited in claim 2 wherein said decision making unit declares the presence of direct sequence spread spectrum signals if the following condition can hold true:
$$\frac{{max}_{m} \{ {A}_{m} ( N ) \}}{{E}_{r} ( N )} > 1 / ρ , N = {N}_{1} , {N}_{1} + 1 , … {N}_{2}$$
where N₂>N₁, N₁ and N₂ are positive integers,
$${max}_{m} \{ {A}_{m} ( N ) \}$$
denotes the maximum of said accumulation sequence, Eᵣ(N) denotes said statistic of said sample sequence, and ρ is said predetermined threshold.

5. The apparatus as recited in claim 1 wherein said third means evaluates said statistic over (N−1) times L number of samples of said sample sequence.

6. The apparatus as recited in claim 5 wherein said statistic of said sample sequence, Eᵣ(N), is given by:
$${E}_{r} ( N ) = {\sum }_{n = 0}^{( N - 1 ) \cdot L - 1} {\vert r ( n ) \vert}^{2}$$
where n denotes a time instant and r(n) denotes a sample of said sample sequence {r(n)} at time instant n.

7. The apparatus as recited in claim 5 wherein said statistic of said sample sequence, Eᵣ(N), can be approximated by the following equation:
$${E}_{r} ( N ) = {\sum }_{n = 0}^{( N - 1 ) \cdot L - 1} \vert r ( n ) \vert$$
where n denotes a time instant and r(n) denotes a sample of said sample sequence {r(n)} at time instant n.

8. A method for detection of direct sequence spread spectrum signals in networking systems, comprising the steps of:
taking a sample sequence from a preamble of a newly arrived network packet;
calculating a sequence of correlation measures between said sample sequence and a pseudo-noise code sequence of length L, where L is a positive integer;
calculating an accumulation sequence in which each accumulation value thereof is obtained by summing N correlation measures that are selected at an interval of L from said sequence of correlation measures, where N is a predetermined integer number;
evaluating a statistic of said sample sequence over a multiple of L number of samples; and
determining the presence of direct sequence spread spectrum signals based on a comparison between said statistic of said sample sequence and a predetermined threshold scaled by the maximum of said accumulation sequence.

9. The method as recited in claim 8 wherein said accumulation sequence, {Aₘ(N)}, comprises L number of effective accumulation values and is calculated from said sequence of correlation measures, {C(n)}, by the following equation:
$${A}_{m} ( N ) = {\sum }_{k = 0}^{N - 1} C ( m + k \cdot L ) , m = 0 , 1 , 2 , … , L - 1$$
where n denotes a time instant, m denotes an integer index, C(n) denotes one of said correlation measures at time instant n, and Aₘ(N) denotes one of said accumulation values at index m.

10. The method as recited in claim 9 wherein said determining step declares the presence of direct sequence spread spectrum signals if the following condition can hold true:
$$\frac{{max}_{m} \{ {A}_{m} ( N ) \}}{{E}_{r} ( N )} > 1 / ρ$$
where
$${max}_{m} \{ {A}_{m} ( N ) \}$$
denotes the maximum of said accumulation sequence, Eᵣ(N) denotes said statistic of said sample sequence, and ρ is said predetermined threshold.

11. The method as recited in claim 9 wherein said determining step declares the presence of direct sequence spread spectrum signals if the following condition can hold true:
$$\frac{{max}_{m} \{ {A}_{m} ( N ) \}}{{E}_{r} ( N )} > 1 / ρ , N = {N}_{1} , {N}_{1} + 1 , … {N}_{2}$$
where N₂>N₁, N₁ and N₂ are positive integers,
$${max}_{m} \{ {A}_{m} ( N ) \}$$
denotes the maximum of said accumulation sequence, Eᵣ(N) denotes said statistic of said sample sequence, and ρ is said predetermined threshold.

12. The method as recited in claim 8 wherein said statistic of said sample sequence is evaluated over (N−1) times L number of samples of said sample sequence.

13. The method as recited in claim 12 wherein said statistic of said sample sequence, Eᵣ(N), is given by:
$${E}_{r} ( N ) = {\sum }_{n = 0}^{( N - 1 ) \cdot L - 1} {\vert r ( n ) \vert}^{2}$$
where n denotes a time instant and r(n) denotes a sample of said sample sequence {r(n)} at time instant n.

14. The method as recited in claim 12 wherein said statistic of said sample sequence, Eᵣ(N), can be approximated by the following equation:
$${E}_{r} ( N ) = {\sum }_{n = 0}^{( N - 1 ) \cdot L - 1} \vert r ( n ) \vert$$
where n denotes a time instant and r(n) denotes a sample of said sample sequence {r(n)} at time instant n.

15. A method for detection of direct sequence spread spectrum signals in networking systems, comprising the steps of:
taking a sample sequence from a preamble of a newly arrived network packet;
calculating a sequence of correlation measures between said sample sequence and a pseudo-noise code sequence of length L, where L is a positive integer;
calculating an accumulation sequence, {Aₘ(N)}, from said sequence of correlation measures, {C(n)}, as follows:
$${A}_{m} ( N ) = {\sum }_{k = 0}^{N - 1} C ( m + k \cdot L ) , m = 0 , 1 , 2 , … , L - 1$$
where
n denotes a time instant,
m denotes an integer index,
C(n) denotes a correlation measure of said sequence {C(n)} at time instant n,
Aₘ(N) denotes an accumulation value of said sequence {Aₘ(N)} at index m, and
N is a predetermined integer number;
evaluating a statistic of said sample sequence over a multiple of L number of samples;
normalizing the maximum of said accumulation sequence with respect to said statistic of said sample sequence; and
determining the presence of direct sequence spread spectrum signals based on a comparison between a predetermined threshold and said normalized maximum of said accumulation sequence.

16. The method as recited in claim 15 wherein said normalized maximum of said accumulation sequence, NLAₘₐₓ(N), is obtained by:
$${NLA}_{max} ( N ) = \frac{{max}_{m} \{ {A}_{m} ( N ) \}}{{E}_{r} ( N )}$$
where
$${max}_{m} \{ {A}_{m} ( N ) \}$$
denotes the maximum of said accumulation sequence and Eᵣ(N) denotes said statistic of said sample sequence.

17. The method as recited in claim 16 wherein said determining step declares the presence of direct sequence spread spectrum signals if the following condition can hold true:
NLAₘₐₓ(N)>1/ρ, N=N₁, N₁+1, . . . , N₂
where ρ is said predetermined threshold, N₂>N₁, N₁ and N₂ are positive integers.

18. The method as recited in claim 15 wherein said statistic of said sample sequence is evaluated over (N−1) times L number of samples of said sample sequence.

19. The method as recited in claim 18 wherein said statistic of said sample sequence, Eᵣ(N), is given by:
$${E}_{r} ( N ) = {\sum }_{n = 0}^{( N - 1 ) \cdot L - 1} {\vert r ( n ) \vert}^{2}$$
where r(n) denotes a sample of said sample sequence {r(n)} at time instant n.

20. The method as recited in claim 18 wherein said statistic of said sample sequence, Eᵣ(N), can be approximated by the following equation:
$${E}_{r} ( N ) = {\sum }_{n = 0}^{( N - 1 ) \cdot L - 1} \vert r ( n ) \vert$$
where n denotes a time instant and r(n) denotes a sample of said sample sequence {r(n)} at time instant n.
